(19) United States
(12) Patent Application Publication
(10) Pub. No.: US 2010/0033530 A1
(43) Pub. Date: Feb. 11, 2010

(54) PRIMING SYSTEM FOR PRINTER HEADS OF PRINTING DEVICES

(76) Inventors: Justin Paul Bryant, Lexington, KY (US); Colin Geoffrey Maher, Georgetown, KY (US); Sam Norasak, Lexington, KY (US); Kent Lee Ubellacker, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/186,614

(22) Filed: Aug. 6, 2008

(51) Int. Cl. B41J 2/165

(52) U.S. Cl. 347/30

(57) ABSTRACT

A priming system for priming a print head of a printing device includes an elongated hollow member, a piston mechanism, a piston driving mechanism, and a suction cup. The piston mechanism disposed in the elongated hollow member is capable of reciprocally moving in a first direction and in a second direction opposite to the first direction within the elongated hollow member. The piston driving mechanism is operatively connected to the piston mechanism at an end portion of the elongated hollow member. The piston driving mechanism is capable of reciprocally moving the piston mechanism in the first direction and in the second direction. The suction cup is disposed above the print head and operatively coupled to the elongated hollow member. The suction cup is capable of extracting ink from a plurality of nozzles of the print head, when the piston mechanism moves in the first direction.

### FIELD OF THE INVENTION

The present invention relates generally to printing devices, and more particularly, to a priming system for priming print heads of the printing devices.

### BACKGROUND

Printing devices are extensively used by people for printing documents stored in an electronic form in physical print media such as paper. Printing devices, especially inkjet printers, are increasingly popular for recording permanent images on paper. These inkjet printers operate by directing a stream of minute ink droplets onto the paper so as to produce a final image on the paper. The ink is directed through nozzles configured on a print head of an inkjet printer.

When the printing device is idle and the print head is not capped, contaminants such as stray droplets of ink, air bubbles, dust particles, dried ink and other debris may accumulate around the nozzles. Further, these contaminants interfere with the trajectory of subsequently ejected ink droplets and affect printing quality. To maintain the printing quality and to meet the requirement of a longer life of the print head, usually the print head is periodically cleaned and primed. Specifically, the nozzles present in the print head are periodically primed to increase the life of the print head. As a result, many of the printing devices are provided with prime stations for priming the nozzles of the print head. During a priming operation, a prime station of the printing device draws ink from an ink reservoir through the nozzles. Thereafter, the contaminants along with the ink are extracted from the nozzles by the prime station. The prime station is usually operated by controlling systems configured in the printing device, which are especially employed for the prime station. Employment of such controlling systems results in addition of more components to the printing device, which in tarn, increases the cost of production of the printing device.

Moreover, many prime stations use a pump system such as a peristaltic pump system for performing the priming operation of the print head. The peristaltic pump system extracts the contaminants along with the ink from the nozzles by generating a vacuum pull in a slow and steady manner. However, such peristaltic pump system may allow some contaminants such as the air bubbles, dried ink, etc., to remain within the nozzles. Moreover, the priming operation may be slow and time consuming.

In addition to the above, the peristaltic pump system may have a tube to hold the contaminants and the ink. The tube may have a shorter life span due to frequent exposure to compression and decompression modes of the peristaltic pump system while extracting and discharging the extracted contaminants and the ink. Furthermore, the tube used in the peristaltic pump system employed for priming operation may need to be varied in size depending on the volume of the ink that needs to be primed. Such process of using the tubes of varying sizes may increase complexity of usage of such prime stations.

Based on the foregoing, there is a need for a priming system that is capable of performing the priming operation in an effective manner. Further, operation of the priming system should be less complex, and the employment of the priming system should be cost effective.

### SUMMARY OF THE INVENTION

In view of the foregoing disadvantages inherent in the prior art, a general purpose of certain embodiments of the present invention is to provide an improved priming system for printing devices.

In one aspect, the present invention provides a priming system for priming a print head of a printing device. The priming system includes an elongated hollow member having a first end portion and a second end portion opposite to the first end portion, a piston mechanism, a piston driving mechanism, and a suction cup. The piston mechanism is disposed in the elongated hollow member. The piston mechanism is capable of reciprocally moving in a first direction and in a second direction opposite to the first direction within the elongated hollow member. The piston driving mechanism is operated by a paper feed motor of the printing device. The piston driving mechanism is operatively connected to the piston mechanism at the first end portion of the elongated hollow member. The piston driving mechanism is capable of reciprocally moving the piston mechanism in the first direction and in the second direction within the elongated hollow member. The suction cup is disposed above the print head and is operatively coupled to the elongated hollow member. When the piston mechanism moves in the first direction, the suction cup extracts ink from a plurality of nozzles of the print head into the elongated hollow member.

In another aspect, the present invention provides a priming system for priming a print head of a printing device. The priming system includes an elongated hollow member having a first end portion and a second end portion opposite to the first end portion, a piston mechanism, a piston driving mechanism, and a suction cup. The piston mechanism is disposed in the elongated hollow member. The piston mechanism is capable of reciprocally moving in a first direction and in a second direction opposite to the first direction within the elongated hollow member. The piston driving mechanism is operated by a wiper motor of the printing device. The piston driving mechanism is operatively connected to the piston mechanism at the first end portion of the elongated hollow member. The piston driving mechanism is capable of reciprocally moving the piston mechanism in the first direction and in the second direction within the elongated hollow member. The suction cup is disposed above the print head and is operatively coupled to the elongated hollow member. When the piston mechanism moves in the first direction, the suction cup extracts ink from a plurality of nozzles of the print head into the elongated hollow member.

In yet another aspect, the present invention provides a priming system for priming a print head of printing device. The priming system includes an elongated hollow member having a first end portion and a second end portion opposite to the first end portion, a piston mechanism, a piston driving mechanism, a suction cup and a container. The piston mechanism is disposed in the elongated hollow member. The piston mechanism is capable of reciprocally moving in a first direction and in a second direction opposite to the first direction within the elongated hollow member. The piston driving mechanism is operated by a wiper motor of the printing device. The piston driving mechanism is operatively connected to fee piston mechanism at the first end portion of the elongated hollow member. The piston driving mechanism is capable of reciprocally moving the piston mechanism in the first direction and in the second direction within the elongated hollow member. The suction cup is disposed above the print head and is operatively coupled to the elongated hollow member. The container is operatively coupled to the elongated hollow member at the second cud portion of the elongated hollow member and to the suction cup. When the piston mechanism moves in the first direction, the suction cup extracts ink from a plurality of nozzles of the print head into the container.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1A and 1B are schematic diagrams, depleting components of an exemplary priming system operated by a paper feed motor embodying the present invention;

FIG. 2 is a schematic diagram, depicting a gear mechanism of the exemplary priming system of FIGS. 1A and 1B;

FIGS. 3A and 3B are schematic diagrams, depicting components of an exemplary priming system operated by a wiper motor embodying the present invention;

FIG. 4 is a schematic diagram, depicting a gear mechanism present in the exemplary priming system of FIGS. 3A and 3B: and

FIGS. 5A and 5B are schematic diagrams, depicting components of another exemplary priming system operated by a wiper motor embodying the present invention.

### DETAILED DESCRIPTION

It is to be understood that the present invention is not limited in its application to the details of construction and the arrangement of components set forth in the following description or illustrated in the drawings. The present invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” “disposed” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in a software. As such, it should be noted that a plurality of hardware and software-based devices, as well as a plurality of different structural components may be utilized to implement the present invention. Furthermore, and as described in subsequent paragraphs, the specific mechanical configurations illustrated in the drawings are intended to exemplify embodiments of the present invention and that other alternative mechanical configurations are possible.

The present invention provides a priming system for priming a print head of a printing device. The term “deprime” as used herein denotes a stage of the print head when the print head is hindered in the printing operation by clogging of air bubbles within nozzles of the print head and/or due to other print head problems, such as nozzle contaminants in the nozzles. One of skill in the art will readily understand that clogging of the print head by air bubbles and other nozzle contaminants can lead to a loss of connection between the nozzles of the print head and an ink reservoir of the printing device.

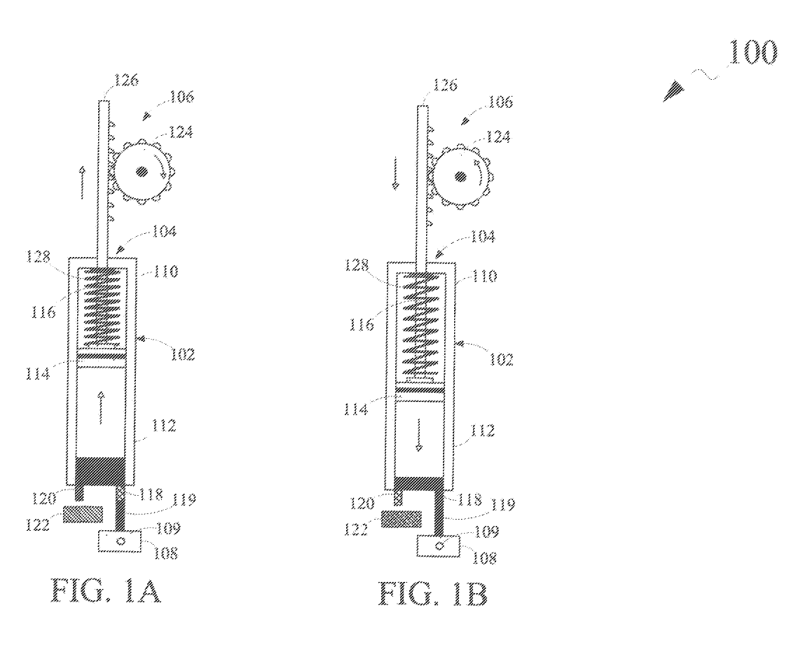

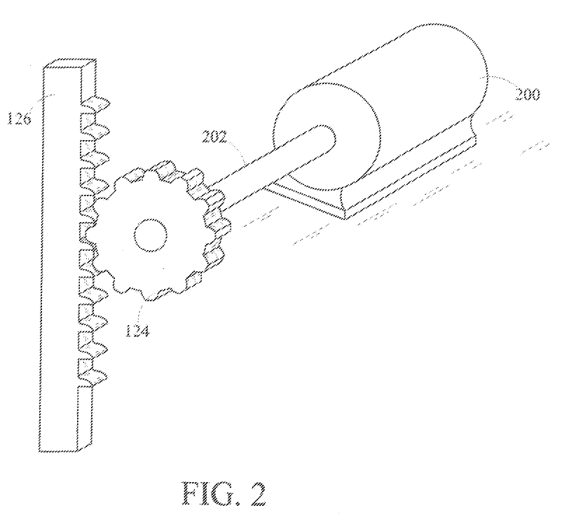

Referring now to the drawings and particularly to FIGS. 1A, 1B and 2, there are shown diagrammatic depictions of components of a priming system 100 operated by a paper feed motor 200 embodying the present invention and of a gear mechanism of priming system 100 operated by paper feed motor 200. Priming system 100 is capable of priming a print head (not shown) of a printing device (not shown) such as an inkjet printer. Priming system 100 includes an elongated hollow member 102, a piston mechanism 104, a piston driving mechanism 106 and a suction cup 108. Elongated hollow member 102 has a first end portion 110 and a second end portion 112 that is opposite to first end portion 110.

Piston mechanism 104 is disposed in elongated hollow member 102. Piston mechanism 104 is capable of reciprocally moving in a first direction for example, upwardly, and in a second direction for example, downwardly, opposite to the first direction within elongated hollow member 102. Piston mechanism 104 includes a piston head 114 and a piston shaft 116 connected to piston head 114. In one embodiment of the present invention, piston head 114 may be composed of suitable materials such as a rubber material or a plastic material. Piston mechanism 104 is operatively connected to piston driving mechanism 106 at first end portion 110 of elongated hollow member 102. Specifically, piston shaft 116 is coupled to piston driving mechanism 106.

Piston driving mechanism 106 moves piston mechanism 104 in the first direction and in the second direction. In the embodiment shown in FIGS. 1A, 1B and 2, piston driving mechanism 106 may be operated by paper feed motor 200 of the printing device. Paper feed motor 200 is configured to control a feeding mechanism (not shown) for feeding physical print media such as papers, into the printing device for the printing purposes. The configuration of piston driving mechanism 106 has been explained further by specifically referring to FIG. 2.

Suction cup 108 is disposed above the print head of the printing device and is operatively coupled to elongated hollow member 102. In one embodiment of the present invention, suction cup 108 acts as a cap for covering the print head when the printing device is idle. Suction cup 108 has an opening 109 through which suction cup 108 extracts ink along with contaminants (hereinafter referred to as ‘suctioned content’) such as stray droplets of ink, air bubbles, dust particles, dried ink and other debris, from a plurality of nozzles (not shown) of the print head. These contaminants, when present in the print head, can block nozzles in the print head and prevent the nozzles from firing the ink when the printing device is performing a printing operation. Suction cup 108 extracts the suctioned content when piston mechanism 104 moves in the first direction. The suctioned content flows into elongated hollow member 102 from suction cup 108. Specifically, the ink is drawn from an ink reservoir (not shown) of the printing device by suction cup 108. Thereafter the ink passes through the plurality of nozzles of the print head.

Suction cup 108 is operatively coupled to elongated hollow member 102 through a first valve 118, which is disposed in second end portion 112 of elongated hollow member 102. More specifically, suction cup 108 is coupled to first valve 118 through a passage 119, which facilitates the flow of the ink between suction cup 108 and elongated hollow member 102. First valve 118 may be coupled with opening 109 of suction 108. First valve 118 is capable of allowing the suctioned content to flow into elongated hollow member 102. More specifically, the suctioned content is stored in second end portion 112 of elongated hollow member 102. It is apparent to a person skilled in the art that a position of first valve 118 as shown in FIGS. 1A and 1B is for the exemplary purposes only and first valve 118 may be configured at any portion of elongated hollow member 102. In one embodiment of the present invention, first valve 118 may be a one way valve configured to allow the suctioned content to flow in one direction i.e., into elongated hollow member 102 from suction cup 108.

In another embodiment of the present invention, elongated hollow member 102 further includes a second valve 120. Second valve 120 may be disposed in second end portion 112 of elongated hollow member 102. Second valve 120 is capable of discharging the suctioned content into a dump site 122, when piston mechanism 104 moves in the second direction. More specifically, when piston mechanism 104 moves towards the second direction, piston mechanism 104 creates an air pressure by compressing the air within elongated hollow member 102. The air pressure is applied at second valve 120, which opens second valve 120, thereby discharging the suctioned content from elongated hollow member 102 to dump site 122. In one embodiment of the present invention, second valve 120 may be a one way valve configured to allow the suctioned content to flow in one direction, i.e., from elongated hollow member 102 into dump site 122. It will be apparent to a person skilled in the art that dump site 122 may be placed at any suitable place in the printing device and may be operatively coupled to second valve 120.

Dump site 122 enables priming system 100 to discharge the suctioned content, when elongated hollow member 102 has less capacity. Moreover, presence of dump site 122 may also reduce frequent replacement of elongated hollow member 102 of a smaller size with elongated hollow members 102 of larger sizes due to increased capacity requirements of priming system 100.

A piston driving mechanism 106 is illustrated in the figures, in accordance with an embodiment of the present invention. Piston driving mechanism 106 includes a first gear 124, a second gear 126 and a spring mechanism 128 (see FIGS. 1A and 1B). First gear 124 is operated by paper feed motor 200 using a drive shaft 202. First gear 124 rotates in a first rotational direction, for example, a clockwise direction and in a second rotational direction, for example, an anti-clockwise direction. In one embodiment of the present invention, paper feed motor 200 may be a stepper motor capable of reciprocally rotating first gear 124 in the first rotational direction and in the second rotational direction. Second gear 126 is releasably engaged with first gear 124. Further, second gear 126 is coupled with piston mechanism 104.

When first gear 124 rotates in the first rotational direction, second gear 126 is adapted to move in the first direction, i.e., upwardly thereby enabling piston mechanism 104 to move in the first direction. Spring mechanism 128 is compressed to achieve a compressed state when piston mechanism 104 moves in the first direction. Further, when first gear 124 rotates in the second rotational direction, second gear 126 gets disengaged from first gear 124. In such case, spring mechanism 128 starts decompressing from the compressed state. With decompression of spring mechanism 128, piston mechanism 104 moves in the second direction, i.e., downwardly. It will be apparent to a person skilled in the art that when first gear 124 rotates in the second rotational direction, paper feed motor 200 may control the feeding mechanism for feeding the physical print media such as papers into the printing device. In one embodiment of the present invention, second gear 126 may be a one way engaging gear. In such an instance, second gear 126 automatically disengages from first gear 124 and moves in the second direction, when first gear 124 rotates in the second rotational direction. It will be apparent to a person skilled in the art that piston driving mechanism 106 may have various configurations other than the configuration described above, in order to enable the movement of piston mechanism 104 between the first direction and the second direction.

Priming operation of the print head may be explained as follows. During a priming operation, first gear 124 moves in the first rotational direction to enable second gear 126 to move in the first direction, i.e., upwardly, as shown in FIG. 1A. Second gear 126 moving in the first direction enables piston mechanism 104 to move in the first direction as shown in FIG. 1A. Once piston mechanism 104 moves in the first direction, piston mechanism 104 starts sucking air within elongated hollow member 102 through the opening of first valve 118. As a result, with the sucking of the air, the suctioned content is extracted from the plurality of nozzles of the print head into elongated hollow member 102 through suction cup 108, passage 119 and first valve 118. While piston mechanism 104 moves in the first direction, spring mechanism 128 starts compressing between piston head 114 and first end portion 110 of elongated hollow member 102.

Thereafter, when first gear 124 moves in the second rotational direction, i.e., the anticlockwise direction, second gear 126 disengages from first gear 124 and moves in the second direction, which is shown in FIG. 1B. When second gear 126 disengages from first gear 124, spring mechanism 128 decompresses allowing piston mechanism 104 to move in the second direction. Piston mechanism 104 moves in second direction to discharge the suctioned content into dump site 122 through second valve 120.

The present invention provides a control of the priming operation as piston mechanism 104 may reciprocally move within elongated hollow member 102 at various speeds depending on varying speed of operation of paper feed motor 200, thereby performing the priming operation at various rates. In such an instance, amount of the suctioned content extracted by suction cup 108 and an extraction speed of suction cup 108 is controlled by paper feed motor 200. Specifically, when paper feed motor 200 runs at a slower speed, piston driving mechanism 106 drives piston mechanism 104 to move in a slower speed. As a result, suction cup 108 may extract less amount of the suctioned content. Similarly, when paper feed motor 200 runs at a faster speed, piston driving mechanism 106 drives piston mechanism 104 to move in a faster speed. Accordingly, suction cup 108 may extract more amount of the suctioned content.

In one embodiment of the present invention, priming system 100 may be controlled by a software module (not shown). In such an instance, when the nozzles of the print head are clogged with air bubbles or contaminants to an extent that a printing operation is negatively impacted, priming system 100 may initiate the priming operation based on instructions received from the software module. In another embodiment of the present invention, priming system 100 may be capable of initiating priming operations after specific time intervals. In yet another embodiment of the present invention, the software module may instruct priming system 100 to initiate the priming operation after a specific amount of the ink is used (as might be determined via ink drop counting or other known methods) for the printing operation.

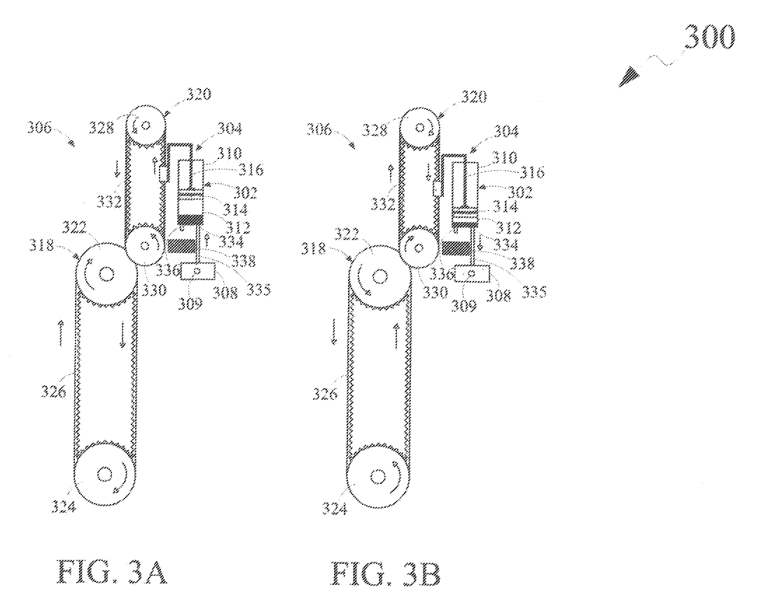

Referring now to FIGS. 3A and 3B, there is shown a schematic depiction of another embodiment of the present invention in the form of a priming system 300 operated by a wiper motor. Priming system 300 is capable of priming a print head of a printing device such as an inkjet printer. Priming system 300 includes an elongated hollow member 302, a piston mechanism 304, a piston driving mechanism 306, and a suction cup 308. Elongated hollow member 302 has a first end portion 310 and a second end portion 312 opposite to first end portion 310.

Piston mechanism 304 is disposed in elongated hollow member 302. Piston mechanism 304 is capable of reciprocally moving in a first direction, for example, upwardly and in a second direction, for example, downwardly within elongated hollow member 302. Piston mechanism 304 includes a piston head 314 and a piston shaft 316 connected to piston head 314. In one embodiment of the present invention, piston head 314 may be composed of suitable materials such as a rubber material or a plastic material. However, it will be apparent to a person skilled in the art that piston head 314 may be composed of any other materials known in the art. Piston mechanism 304 is reciprocally movable in the first direction and in the second direction by piston driving mechanism 306.

Piston mechanism 304 is operatively connected to piston driving mechanism 306 at first end portion 310 of elongated hollow member 302. Specifically, piston shaft 316 may be coupled to piston driving mechanism 306. In this embodiment of the present invention, piston driving mechanism 306 is operated by a wiper motor (not shown) of the printing device (not shown). The wiper motor is configured to control an operation of wiping the print head of the printing device.

In one embodiment of the present invention, piston driving mechanism 306 includes a drive pulley assembly 318 and a driven pulley assembly 320. Drive pulley assembly 318 is driven by the wiper motor to reciprocally rotate between a first rotational direction, for example, a clockwise direction and a second rotational direction, for example, an anti-clockwise direction. Drive pulley assembly 318 includes a first rotatable wheel 322, a second rotatable wheel 324 and a belt 326. Belt 326 may be engaged over first rotatable wheel 322 and second rotatable wheel 324. Second rotatable wheel 324 may be capable of rotating along with first rotatable wheel 322 through belt 326.

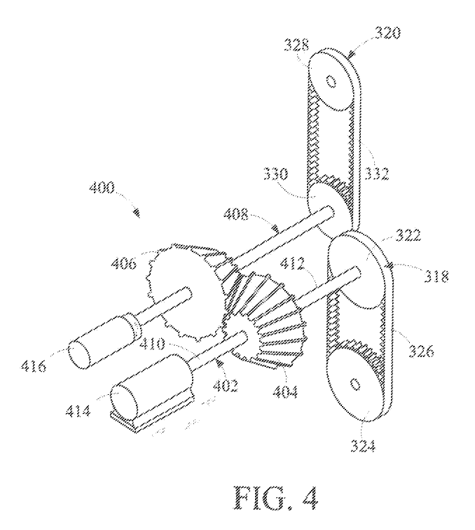

In one embodiment of the present invention, driven pulley assembly 320 is releasably engaged with drive pulley assembly 318 using a gear mechanism (not shown). Specifically, the gear mechanism engages and disengages drive pulley assembly 318 and driven pulley assembly 320. The operation of the gear mechanism and the wiper motor has been explained further in conjunction with FIG. 4.

Driven pulley assembly 320 includes a first rotatable wheel 328, a second rotatable wheel 330, and a belt 332. Belt 332 is engaged over first rotatable wheel 328 and second rotatable wheel 330 such that second rotatable wheel 330 may be capable of rotating along with first rotatable wheel 328. Belt 332 may be coupled to piston mechanism 304. More specifically, belt 332 may be coupled to piston shaft 316 to reciprocate piston mechanism 304 in the first direction and the second direction. It will be apparent to a person skilled in the art that piston driving mechanism 306 may include configurations other than the configuration described above.

Driven pulley assembly 320 is configured to reciprocally rotate between the second rotational direction and the first rotational direction, when drive pulley assembly 318 reciprocally rotates in the first rotational direction and the second rotational direction, respectively. Accordingly, when driven pulley assembly 320 rotates in the second rotational direction, piston mechanism 304 moves in the first direction, i.e., upwardly. Similarly, when driven pulley assembly 320 rotates in the first rotational direction, piston mechanism 304 moves in the second direction, i.e., downwardly.

Piston mechanism 304 while moving in the first direction enables the suction cup 308 to prime the print head of the printing device. In one embodiment of the present invention, suction cup 308 acts as a cap for covering the print head when the printing device is idle. Suction cup 308 is disposed above the print head of the printing device and is operatively coupled to elongated hollow member 302. Suction cup 308 has an opening 309 through which, suction cup 308 extracts suctioned content from a plurality of nozzles of the print head. Suction cup 308 extracts the suctioned content, when piston mechanism 304 moves in the first direction. Thereafter, the suctioned content flows into elongated hollow member 302 from suction cup 308.

Elongated hollow member 302 further includes a first valve 334, which is operatively coupled to suction cup 308 through a passage 335. Suction cup 308 is capable of allowing the suctioned content to flow from suction cup 308 into elongated hollow member 302. More specifically, passage 335 may be connected to opening 309 of suction cup 308 such that the suctioned content from opening 309 is directly passed through passage 335 to first valve 334 of elongated hollow member 302. First valve 334 may be disposed in or near the second end portion 312 of elongated hollow member 302. However, it will apparent to a person skilled in the art that first valve 334 may be configured at any portion of elongated hollow member 302. In one embodiment of the present invention, first valve 334 may be a one way valve configured to allow suctioned content to flow in one direction, i.e., into elongated hollow member 302 from suction cup 308.

In another embodiment of the present invention, elongated hollow member 302 further includes a second valve 336. Second valve 336 may be disposed in or near the second end portion 312 of elongated hollow member 302. Second valve 336 is capable of discharging the suctioned content into a dump site 338, when piston mechanism 304 moves in the second direction. More specifically, when piston mechanism 304 moves towards the second direction, piston mechanism 304 creates an air pressure by compressing the air within elongated hollow member 302. The air pressure is applied at second valve 336, which opens second valve 336, thereby discharging the suctioned content from elongated hollow member 302 to dump site 338. In one embodiment of the present invention, second valve 336 may be a one way valve configured to allow one way direction of flow of the suctioned content from elongated hollow member 302 into dump site 338. It will be apparent to a person skilled in the art that dump site 338 may be placed at any suitable place in the printing device operatively coupled to second valve 336.

Dump site 338 may enable priming system 300 to discharge the suctioned content, when elongated hollow member 302 has less capacity. Moreover, presence of dump site 338 may also reduce frequent replacement of elongated hollow member 302 of a smaller size with elongated hollow members 302 of larger sizes due to increased capacity requirements.

Priming operation of the print head may be explained as follows. During a priming operation, when drive pulley assembly 318 rotates in the first rotational direction for example, the clockwise direction, driven pulley assembly 320 is adapted to rotate in the second rotational direction for example, the anticlockwise direction, which is shown in FIG. 3A. Driven pulley assembly 320 rotating in the second rotational direction enables piston mechanism 304 to move in the first direction as shown in FIG. 3A. Thereafter, piston mechanism 304 starts sucking air within elongated hollow member 302 through the opening of first valve 334. As a result, with the sucking of the air, the suctioned content is extracted from the plurality of nozzles of the print head into elongated hollow member 302 through suction cup 308, passage 335 and first valve 334.

Thereafter, when drive pulley assembly 318 rotates in the second rotational direction for example, the anticlockwise direction, driven pulley assembly 320 is adapted to rotate in the first rotational direction, which is shown in FIG. 3B. Accordingly, piston mechanism 304 moves in the second direction. As piston mechanism 304 starts moving in the second direction, the suctioned content is discharged into dump site 338 through second valve 336.

The present invention provides a control of the priming operation as piston mechanism 304 may reciprocally move within elongated hollow member 302 at various speeds depending on varying speed of operation of the wiper motor, thereby performing the priming operation at various speeds. In such an instance, amount of the suctioned content extracted by suction cup 308 and an extraction speed of suction cup 308 may be controlled by the wiper motor. Specifically, when the wiper motor runs at a slower speed, piston driving mechanism 306 drives piston mechanism 304 to move in a slower speed. As a result, suction cup 308 may extract less amount of the suctioned content. Similarly, when the wiper motor runs at a faster speed, piston driving mechanism 306 drives piston mechanism 304 to move in a faster speed. Consequently, suction cup 308 may extract more amount of the suctioned content.

In one embodiment of the present invention, priming system 300 may be controlled by a software module (not shown). In such an instance, when the nozzles of the print head are clogged with air bubbles or other contaminants such that the print quality of a printing operation is impacted, priming system 300 may initiate the priming operation based on instructions from the software module. In another embodiment of the present invention, priming system 300 may be capable of initiating priming operations after specific time intervals. In yet another embodiment of the present invention, the software module may instruct priming system 300 to initiate the priming operation after a specific amount of ink is used for the printing operation.

Referring now to FIG. 4, there is shown an exemplary gear mechanism 400 that may be used in connection with the priming system 300 of FIGS. 3A and 3B. Specifically, FIG. 4 shows drive pulley assembly 318 and driven pulley assembly 320 disengageably engaging with each other using gear mechanism 400. Gear mechanism 400 includes a first shaft 402, a primary gear 404, a secondary gear 406, and a second shaft 408. First shaft 402 has a proximal end 410 and a distal end 412. Proximal end 410 of first shaft 402 may be connected to a wiper motor 414. Distal end 412 of first shaft 402 may be connected to drive pulley assembly 318. Specifically, distal end 412 of first shaft 402 may be connected to first rotatable wheel 322 of drive pulley assembly 318. Primary gear 404 is disposed on first shaft 402 and is positioned between proximal end 410 and distal end 412 of first shaft 402.

Secondary gear 406 is disengageably engaged with primary gear 404. Secondary gear 406 may be connected to driven pulley assembly 320 through second shaft 408. Specifically, second shaft 408 may be connected to second rotatable wheel 330 of driven pulley assembly 320. During operation, primary gear 404 may be driven by wiper motor 414 to reciprocally rotate in the first rotational direction, for example, the clockwise direction and the second rotational direction, for example, the anticlockwise direction. Wiper motor 414 may also be configured to control a wiping operation for wiping the print head simultaneously while driving primary gear 404. More specifically, second rotatable wheel 324 of drive pulley assembly 318 may be connected to a shaft (not shown) coupled to a maintenance wiper station (not shown) configured to control the wiping operation.

When primary gear 404 engages with secondary gear 406, the reciprocal rotational movement of primary gear 404 is transferred to secondary gear 406. As a result, secondary gear 406 reciprocally rotates in the second rotational direction for example, the anticlockwise direction and the first rotational direction for example, the clockwise direction. Specifically, when primary gear 404 rotates in the first rotational direction, then secondary gear 406 rotates in the second rotational direction thereby enabling driven pulley assembly 320 to rotate in the second rotational direction. Further, when primary gear 404 rotates in the second rotational direction, then secondary gear 406 rotates in the first rotational direction thereby enabling driven pulley assembly 320 to rotate in the first rotational direction.

In one embodiment of the present invention, secondary gear 406 may be coupled with a solenoid control mechanism 416. Solenoid control mechanism 416 may be coupled to secondary gear 406 through a shaft. Solenoid control mechanism 416 may be configured to engage and disengage secondary gear 406 with primary gear 404. Specifically, solenoid control mechanism 416 may engage secondary gear 406 with primary gear 404 when the priming operation has to be performed. Further, solenoid control mechanism 416 may disengage secondary gear 406 from primary gear 404 when the priming operation has to be stopped. In such an instance, wiper motor 414 may continue to execute the wiping operation. Such solenoid control mechanism 416 enables the priming system such as priming system 300 to avoid unnecessary functioning of priming system 300 during the wiping operation and to prevent overloading of wiper motor 414. Further, solenoid control mechanism 416 may enable priming system 300 to avoid excessive wear of piston mechanism 304. In one embodiment of the present invention, the solenoid control mechanism 416 may be controlled by the software module.

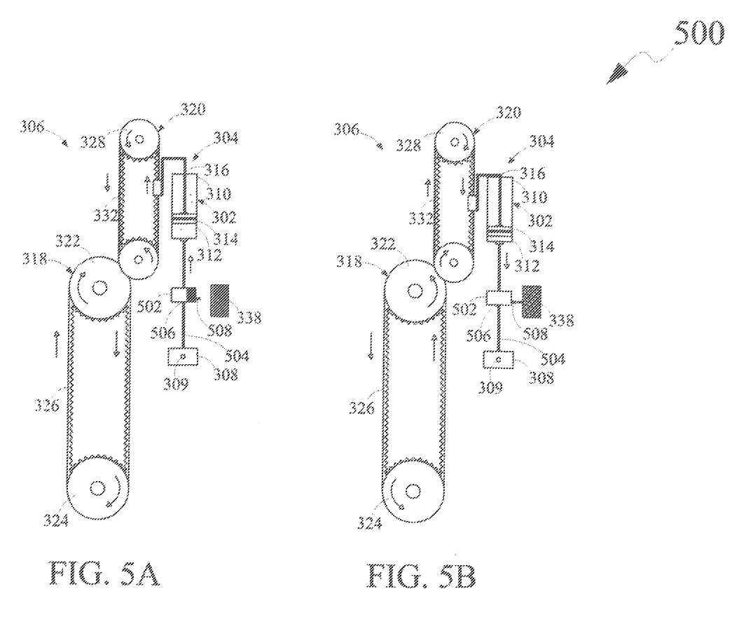

Further, referring now to FIGS. 5A and 5B, there is shown a schematic depiction of a priming system 500 operated by the wiper motor, in accordance with another embodiment of the present invention. Priming system 500 is similar to priming system 300 except for introduction of a container 502. Further, priming system 500 includes a gear mechanism similar to gear mechanism 400 (see FIG. 4) of priming system 300. Therefore, the various components, which are same in both priming systems 300 and 500, are referred by the same reference numerals. Hence, the corresponding description of these components may be entirely referred from their description in conjunction with FIGS. 3A and 3B.

Priming system 500 includes container 502, which is operatively coupled to elongated hollow member 302. More specifically, container 502 is operatively coupled between elongated hollow member 302 and suction cup 308. Container 502 is coupled to suction cup 308 through a passage 504, which is connected to opening 309 of suction cup 308. During operation, when piston mechanism 304 moves in the first direction to enable suction cup 308 to extract suctioned content from the plurality of nozzles of the print head. The suctioned content is collected in container 502. Container 502 may be configured in a manner to prevent the suctioned content from flowing into elongated hollow member 302. In one embodiment of the present invention, container 502 includes a first valve 506 capable of enabling the suctioned content to flow from suction cup 308 into container 502 through passage 504. In another embodiment of the present invention, container 502 includes a second valve 508 capable of discharging the suctioned content into dump site 338. Second valve 508 discharges the suctioned content when piston mechanism 304 moves in the second direction.

It will also be evident from the description of FIGS. 1A, 1B, 3A, 3B, 5A and 5B to persons skilled in the art that elongated hollow members 102, 302 and 302 of priming systems 100, 300 and 500 respectively, may be replaced with structures of varying shapes and sizes depending on the specific requirements of a corresponding priming system.

The foregoing description of several methods and an embodiment of the invention have been presented for purposes of illustration. It is not intended to be exhaustive or to limit the invention to the precise steps and/or forms disclosed, and obviously many modifications and variations are possible in light of the above description. It is intended that the scope of the invention be defined by the claims appended hereto.

What is claimed is:

1. A priming system for priming a print head of a printing device, the priming system comprising:
a hollow member having a first end portion and a second end portion opposite the first end portion;
a piston mechanism disposed in the hollow member, the piston mechanism capable of reciprocally moving in a first direction and in a second direction opposite to the first direction;
a piston driving mechanism operated by a paper feed motor of the printing device, the piston driving mechanism operatively connected to the piston mechanism, the piston driving mechanism capable of reciprocally moving the piston mechanism in the first direction and in the second direction; and
a suction cup operatively coupled to the hollow member, the suction cup configured to extract ink from a plurality of nozzles of the print head into the hollow member, when the piston mechanism moves in the first direction.

2. The priming system of claim 1, wherein the hollow member further comprises a first valve disposed in the hollow member and operatively coupled to the suction cup, the first valve enabling the ink to flow from the suction cup into the hollow member.

3. The priming system of claim 2, wherein the first valve is a one way valve.

4. The priming system of claim 2, wherein the hollow member further comprises a second valve disposed the hollow member, the second valve capable of discharging the ink from the hollow member into a dump site.

5. The priming system of claim 4, wherein the second valve is a one way valve.

6. The priming system of claim 1, wherein the piston driving mechanism comprises:
a first gear operated by the paper feed motor, the first gear capable of rotating in a first rotational direction and in a second rotational direction;
a second gear releasably engaged with the first gear and connected to the piston mechanism, the second gear adapted to move in the first direction when the first gear moves in the first rotational direction thereby enabling the piston mechanism to move in the first direction, and the second gear further adapted to be disengaged from the first gear when the first gear moves in the second rotational direction; and
a spring mechanism operatively coupled to the piston mechanism, the spring mechanism capable of being compressed by the piston mechanism when the piston mechanism moves in the first direction, and the spring mechanism further capable of being decompressed when the second gear is disengaged from the first gear thereby moving the piston mechanism in the second direction.

7. A priming system for priming a print head of a printing device, the priming system comprising:
a hollow member having a first end portion and a second end portion opposite to the first end portion;
a piston mechanism disposed in the hollow member, the piston mechanism capable of reciprocally moving in a first direction and in a second direction opposite to the first direction;
a piston driving mechanism operated by a wiper motor of the printing device and operatively connected to the piston mechanism, the piston driving mechanism capable of reciprocally moving the piston mechanism in the first direction and in the second direction; and
a suction cup operatively coupled to the hollow member, the suction cup capable of extracting ink from a plurality of nozzles of the print head into the hollow member.

8. The priming system of claim 7, wherein the piston driving mechanism comprises:
a drive pulley assembly driven by the wiper motor to reciprocally rotate between a first rotational direction and a second rotational direction; and
a driven pulley assembly releasably engaged with the drive pulley assembly, the driven pulley assembly configured to reciprocally rotate between the second rotational direction and the first rotational direction depending on the reciprocal rotation of the drive pulley assembly between the first rotational direction and the second rotational direction respectively, thereby enabling the piston mechanism to move in the first direction and in the second direction, respectively.

9. The priming system of claim 8, wherein the piston driving mechanism further comprises a gear mechanism for engaging and disengaging the driven pulley assembly with the drive pulley assembly.

10. The priming system of claim 9, wherein the gear mechanism comprises:
a first shaft having a proximal end and a distal end, the proximal end of the first shaft connected to the wiper motor and the distal end of the first shaft connected to the drive pulley assembly;
a primary gear disposed at the first shaft between the proximal end and the distal end of the first shaft;
a secondary gear releasably engaged with the primary gear, the secondary gear connected to the driven pulley assembly through a second shaft; and
a solenoid control mechanism coupled to the secondary gear, the solenoid control mechanism configured to engage and disengage the secondary gear with the primary gear.

11. The priming system of claim 10, wherein the drive pulley assembly comprises:
a first rotatable wheel connected to the first shaft; and
a second rotatable wheel capable of rotating along with the first rotatable wheel through a belt, wherein the belt is engaged over the first rotatable wheel and the second rotatable wheel.

12. The priming system of claim 10, wherein the driven pulley assembly comprises:
a first rotatable wheel connected to the second shaft; and
a second rotatable wheel capable of rotating along with the first rotatable wheel through a belt, wherein the belt is engaged over the first rotatable wheel and the second rotatable wheel.

13. The priming system of claim 7, wherein the hollow member comprises a first valve operatively coupled to the suction cup, the first valve enabling the ink to flow from the suction cup into the hollow member.

14. The priming system of claim 7, wherein the hollow member comprises a second valve capable of discharging the ink from the hollow member into a dump site.

15. A priming system for priming a print head of a printing device, the priming system comprising:
an elongated hollow member having a first end portion and a second end portion opposite to the first end portion;
a piston mechanism disposed in the elongated hollow member, the piston mechanism capable of reciprocally moving in a first direction and in a second direction opposite to the first direction within the elongated hollow member;
a piston driving mechanism operated by a wiper motor of the printing device and operatively connected to the piston mechanism at the first end portion of the elongated hollow member, the piston driving mechanism capable of reciprocally moving the piston mechanism in the first direction and in the second direction; and
a suction cup disposed above the print head and operatively coupled to the elongated hollow member, the suction cup capable of extracting ink from a plurality of nozzles of the print head into a container, when the piston mechanism moves in the first direction, wherein the container is operatively coupled to the elongated hollow member at the second end portion of the elongated hollow member and is operatively coupled to the suction cup.

16. The priming system of claim 15, wherein the container comprises:
a first valve, the first valve capable of enabling the ink to flow from the suction cup into the container when the piston mechanism moves in the first direction within the elongated hollow member; and
a second valve, the second valve capable of discharging the ink from the container into a dump site when the piston mechanism moves in the second direction within the elongated hollow member.

17. The priming system of claim 15, wherein the piston driving mechanism comprises:
a drive pulley assembly driven by the wiper motor to reciprocally rotate between a first rotational direction and a second rotational direction; and
a driven pulley assembly releasably engaged with the drive pulley assembly, the driven pulley assembly configured to reciprocally rotate between the second rotational direction and the first rotational direction depending on the reciprocal rotation of the drive pulley assembly between the first rotational direction and the second rotational direction respectively, thereby enabling the piston mechanism to move in the first direction and in the second direction, respectively.

18. The priming system of claim 17, wherein the piston driving mechanism further comprises a gear mechanism for engaging and disengaging the driven pulley assembly with the drive pulley assembly, wherein the gear mechanism comprises:
a first shaft having a proximal end and a distal end, the proximal end of the first shaft connected to the wiper motor and the distal end of the first shaft connected to the drive pulley assembly;
a primary gear disposed at the first shaft between the proximal end and the distal end of the first shaft;
a secondary gear releasably engaged with the primary gear, the secondary gear connected to the driven pulley assembly through a second shaft; and
a solenoid control mechanism coupled to the secondary gear, the solenoid control mechanism configured to engage and disengage the secondary gear with the primary gear.

19. The priming system of claim 18, wherein the drive pulley assembly comprises:
a first rotatable wheel connected to the first shaft; and
a second rotatable wheel capable of rotating along with the first rotatable wheel through a belt, wherein the belt is engaged over the first rotatable wheel and the second rotatable wheel.

20. The priming system of claim 18, wherein the driven pulley assembly comprises:
a first rotatable wheel connected to the second shaft; and
a second rotatable wheel capable of rotating along with the first rotatable wheel through a belt, wherein the belt is engaged over the first rotatable wheel and the second rotatable wheel.
